(19) United States
(12) Patent Application Publication
(10) Pub. No.: US 2026/0035293 A1
(43) Pub. Date: Feb. 5, 2026

(54) SUBSTRATES WITH ALKALI DEPLETION REGION

(71) Applicant: CORNING INCORPORATED, CORNING, NY (US)

(72) Inventors: Cody Vic Cushman, Painted Post, NY (US); Charles Thomas McLaren, Elmira, NY (US); Chukwudi Azubuike Okoro, Painted Post, NY (US); Robert Anthony Schaut, Horseheads, NY (US); Nicholas James Smith, Port Matilda, PA (US)

(21) Appl. No.: 19/275,159

(22) Filed: Jul. 21, 2025

Related U.S. Application Data
(60) Provisional application No. 63/677,704, filed on Jul. 31, 2024.

(51) Int. Cl. C03C 17/06; C03C 3/091; C03C 23/00

(52) U.S. Cl. CPC C03C 17/06; C03C 3/091; C03C 23/009

(57) ABSTRACT

An article that includes a substrate with a first surface and a second surface and that has a bulk region and a surface modified region, the bulk region being integral with the surface modified region, and the surface modified region being at the first surface of the substrate. The bulk region including a higher concentration of at least one alkali than the surface modified region, and where a metal coating is disposed on the first surface of the substrate.

This application claims the benefit of priority to U.S. Provisional Patent Application Ser. No. 63/677,704 filed on Jul. 31, 2024, the content of which is relied upon and incorporated herein by reference in its entirety.

### FIELD

The disclosure relates to substrates with a modified surface region and, more particularly, to substrates with an alkali depletion region including methods and systems for forming such alkali depletion regions.

### BACKGROUND

There is an increase in market demand for computing platforms, such as desktops, laptops, and smartphones, to have higher and higher performance levels. One way to increase the performance level of these platforms is to integrate more circuit devices into a single package on a chip. But, with such increased integration, performance features such as breakability, warpage, power delivery, and thermal management become even more important. Although various techniques are known to modify the surfaces of glass substrates, there is a need in the art for surface modification techniques that can keep up with the ever increasing performance demands.

### SUMMARY

A first aspect of this disclosure pertains to an article comprising a substrate with a first surface and a second surface and comprising a bulk region and a surface modified region, the bulk region being integral with the surface modified region, and the surface modified region being at the first surface of the substrate, the bulk region comprising a higher concentration of at least one alkali than the surface modified region, and a metal coating being disposed on the first surface of the substrate.

A second aspect of the disclosure pertains to a method of forming a modified surface region on a substrate, the method comprising depositing a metal coating on a first surface of the substrate, creating an electrical potential difference across the substrate while depositing the metal coating on the first surface of the substrate, forming the modified surface region on the first surface of the substrate due to the electrical potential difference across the substrate, the modified surface region being integral with a bulk region of the substrate, and the modified surface region comprising a lower concentration of at least one alkali than the bulk region of the substrate.

### BRIEF DESCRIPTION OF THE DRAWINGS

FIG. 1 is a side view of a substrate that comprises a bulk region and a surface modified region, according to the embodiments disclosed herein;

FIG. 2A is a side view of the substrate of FIG. 1 with an additional metal coating, according to the embodiments disclosed herein;

FIG. 2B is a side view of the substrate of FIG. 1 with an additional metal coating and adhesion layer, according to the embodiments disclosed herein;

FIG. 2C is another side view showing the substate of FIG. 1 with two surface modified regions formed therein and two metal coatings disposed thereon, according to the embodiments disclosed herein;

FIG. 2D is another side view showing the substrate of FIG. 1 with through glass vias formed therethrough and metal coatings disposed thereon, according to the embodiments disclosed herein;

FIG. 3A is a side view of the substrate of FIG. 1 connected to first and second electrodes and a voltage source for the surface modification techniques, according to the embodiments disclosed herein;

FIG. 3B is another side view of the substrate of FIG. 1 showing the electrical potential difference created across the substrate during the surface modification techniques, according to the embodiments disclosed herein; and

FIG. 4 shows a SIMS depth profile for an exemplary example, according to the embodiments disclosed herein.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms, such as up, down, right, left, front, back, top, bottom, above, below, and the like, are made only with reference to the figures as drawn and are not intended to imply absolute orientation.

As used herein, the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, “alkali” means one or more alkali metals and alkaline earth metals and/or oxides thereof and, specifically, the alkali metals and alkaline earth metals and/or oxides thereof present in a substrate (e.g., Li₂O, Na₂O, K₂O, Rb₂O, Cs₂O, BeO, MgO, CaO, SrO, BaO, RaO, and Fr₂O).

As used herein, “alkali-depleted,” used with reference to a volumetric region of a substrate, means the region comprises at least one alkali in a concentration that is less than a concentration of that alkali present in an alkali-containing bulk (or remainder) of the substrate.

As used herein, a “substantially homogeneous composition” refers to a composition that does not exhibit any phase separation or very little phase separation.

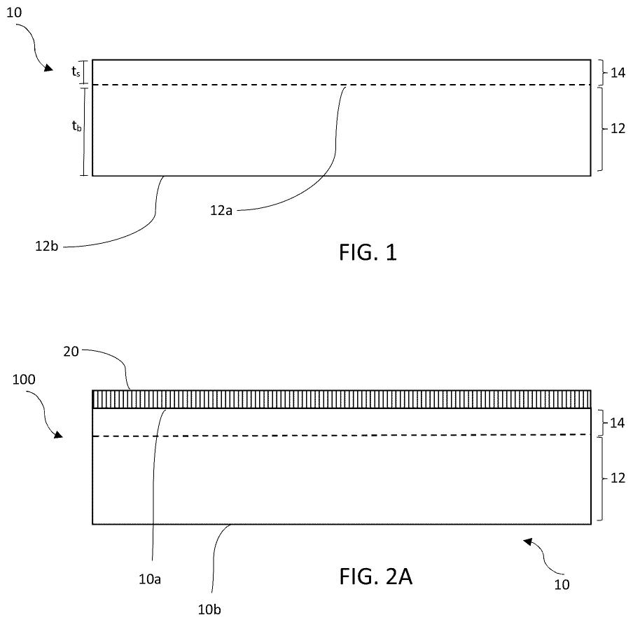

With reference to FIG. 1, a substrate 10 is depicted as comprising a bulk region 12 and a surface modified region 14. Substrate 10 (including both bulk region 12 and surface modified region 14) may be planar and sheet-like or may comprise a curved shape. As discussed further below, the composition of bulk region 12 comprises at least one mobile modifier, such as a mobile alkali. Bulk region 12 comprises the mobile modifier in a larger concentration than that of surface modified region 14. Furthermore, bulk region 12 comprises a first surface 12a and a second surface 12b, and surface modified region 14 extends laterally across bulk region 12. In embodiments, surface modified region 14 extends across an entire surface area of first surface 12a. In other embodiments, surface modified region 14 extends across less than an entire surface of first surface 12a.

Substrate 10 may be circular or rectangular in shape. Thus, in embodiments, substrate 10 may form a circular wafer or a rectangular panel. In some embodiments, substrate 10 has a length and width that are each about 600 mm or less, or about 550 mm or less, or about 520 mm or less, or about 515 mm or less, or about 510 mm or less, or about 500 mm or less. In some particular embodiments, substrate 10 is a rectangular panel with a length and width of 510 mm×515 mm. Substrate 10 may be used in, for example, semiconductor and glass core technologies. For example, substrate 10 may be used in the fabrication of microelectronics to advantageously increase chip density, reduce costs, and improve manufacturing efficiency. As also discussed further below, substrate 10 may be coated with a metal coating and may comprise through glass vias disposed therethrough.

Substrate 10 may comprise a glass or glass-ceramic material so that bulk region 12 and surface modified region 14 are also comprised of a glass or glass-ceramic material. Furthermore, substrate 10 may be, for example, a glass article, glass sample, glass ribbon, or glass sheet. Surface modified region 14 may be integral with bulk region 12 of substrate 10, such that surface modified region 14 is not a coating disposed on bulk region 12. As discussed further below, surface modified region 14 may be formed on bulk region 12 using a surface modification technique on substrate 10. Surface modified region 14 advantageously helps to improve adhesion of bulk region 12 with a metal coating disposed on substrate 10. Furthermore, surface modified region 14 advantageously provides increased electrical resistance of bulk region 12, which helps to achieve low dielectric loss of the substrate.

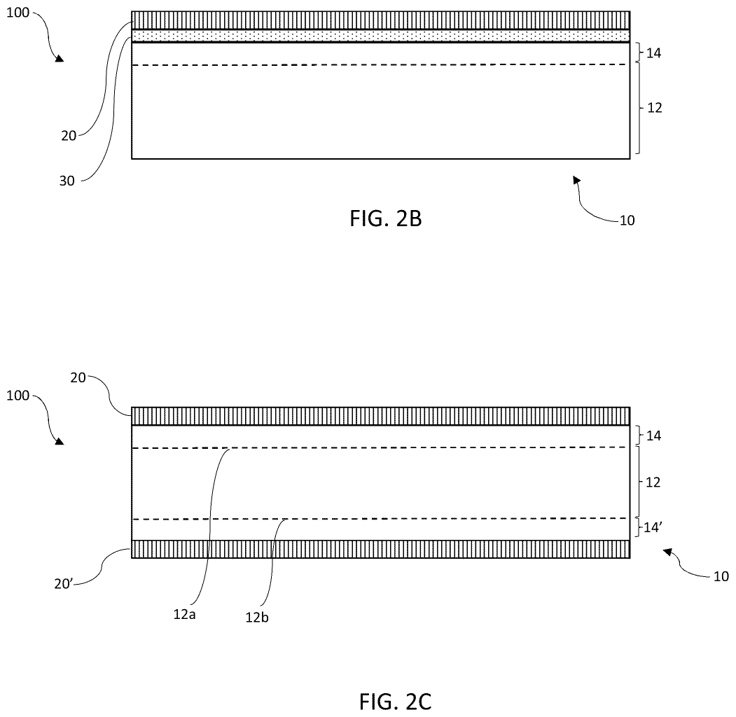

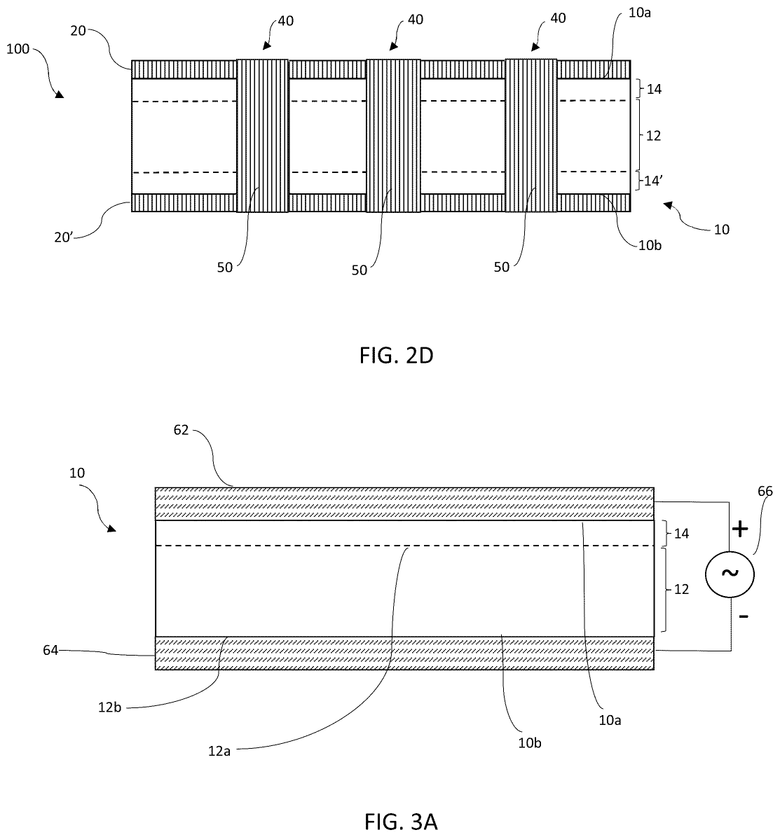

FIG. 2A shows an embodiment of an article 100 that comprises substrate 10 with a metal coating 20 disposed thereon. In particle, metal coating 20 is disposed on a first surface 10a of substrate 10 on which surface modified region 14 is formed (and which is opposed from a second surface 10b of substrate 10). As discussed above, surface modified region 14 improves adhesion between metal coating 20 and bulk region 12 of substrate 10, thus reducing delamination of metal coating 20.

Metal coating 20 may comprise, for example, a metal or metal alloy comprising at least one of copper (Cu), manganese (Mn) titanium (Ti), tin (Sn), indium (In), chromium (Cr), molybdenum (Mo), aluminum (Al), niobium (Nb), tantalum (Ta), vanadium (Va), zinc (Zn), silver (Ag), nickel (Ni), gold (Au), platinum (Pt), palladium (Pd), or combinations thereof. In some embodiments, pure copper is chosen as the metal due to its good conductivity properties.

In embodiments, metal coating 20 has a resistivity in a range of about 1×10⁻⁶ Ω-cm to about 10 Ω-cm, or about 1×10³ Ω-cm to about 0.1 Ω-cm, or about 1×10⁻² Ω-cm to about 0.75 Ω-cm, or about 0.5 Ω-cm to about 1 Ω-cm, or about 0.76 Ω-cm, or about 0.78 Ω-cm, or about 0.80 Ω-cm, or about 0.85 Ω-cm, or any rang encompassing these endpoints.

Metal coating 20 may have thickness in a range from about 50 nm to about 100 microns or about 50 nm to about 50 microns, or about 50 nm to about 20 microns, or about 50 nm to about 10 microns, or about 50 nm to about 5 microns, or about 50 nm to about 1 micron, or about 50 nm to about 800 nm, or about 50 nm to about 500 nm, or about 50 nm to about 250 nm, or about 100 nm to about 200 nm, or about 50 nm, or about 75 nm, or about 100 nm, or about 120 nm, or about 150 nm, or about 175 nm, or about 200 nm, or about 225 nm, or about 250 nm, or any range encompassing these endpoints.

In embodiments, metal coating 20 is formed by a process that comprises electroless deposition, electroplating, physical vapor deposition (PVD), atomic layer deposition (ALD), or a combination thereof. It is also contemplated that metal coating 20 may be deposited by other techniques known in the art. In some embodiments, metal coating 20 comprises a first layer formed by electroless deposition and a second layer formed by electroplating.

FIG. 2B shows another embodiment of article 100 in which an adhesion layer 30 is disposed between metal coating 20 and substrate 10. In particular, adhesion layer 30 is disposed between metal coating 20 and surface modified region 14. Adhesion layer 30 may comprise, for example, titanium (Ti), chrome (Cr), tantalum (Ta), vanadium (V), nickel (Ni), tungsten (W), tungsten titanium (TiW), or molybdenum (Mo), or metal oxides such as zinc oxide, tungsten oxide, and manganese oxide, or nitrides such as titanium nitride (TiN) and tantalum nitride (TaN). Adhesion layer 30 may have thickness from about 1 nm to about 1000 nm, or about 5 nm to about 750 nm, or about 10 nm to about 500 nm, or about 25 nm to about 250 nm, or about 50 nm to about 150 nm, or about 75 nm to about 100 nm, or any range encompassing these endpoints.

In embodiments, adhesion layer 30 is formed by a process that comprises electroless deposition, electroplating, physical vapor deposition (PVD), atomic layer deposition (ALD), or a combination thereof. It is also contemplated that adhesion layer 30 may be deposited by other techniques known in the art.

FIG. 2C shows yet another embodiment of article 100 in which substrate 10 comprises surface modified region 14 on first surface 12a of bulk region 12 and a second surface modified region 14′ on second surface 12b of bulk region 12. As discussed further below, surface modified region 14 and second surface modified region 14′ may both be formed by the same process steps and may both comprise alkali-depleted surface regions. Furthermore, as shown in FIG. 2C, article 100 comprises metal coating 20 on surface modified region 14 and a second metal coating 20′ on second modified surface region 14′. Second metal coating 20′ may comprise any of the materials disclosed above with regard to metal coating 20 and may comprise the same or different material from metal coating 20. Although not shown in FIG. 2, it is also contemplated that article 100 may comprise an adhesion layer 30 between surface modified region 14 and metal coating 20 and/or between second surface modified region 14′ and second metal coating 20′.

In the embodiment of FIG. 2D, article 100 comprises substrate 10 with through glass vias 40 disposed therethrough. Furthermore, in this embodiment, metal connectors 50 are disposed within through glass vias 40. It is also contemplated that article 100 may comprise substrate 100 with through glass vias 40 disposed therethrough but without metal connectors 50. Through glass vias 40 may extend through an entire thickness of substrate 10 from first side 10a to second side 10b of substrate 10, or through glass vias 40 may extend less than the entire thickness of substrate 10 (e.g., blind vias). FIG. 2D shows through glass vias 40 as having a cylindrical cross-sectional shape. However, through glass vias 40 may comprise other cross-sectional shapes such as, for example, hourglass, barbell, and/or beveled.

In some embodiments, through glass vias 40 comprise a waist with a diameter that is at least about 50%, or at least about 55%, or least about 60%, or at least about 65% or least about 70%, or at least about 75%, or at least about 80% of the diameter of an opening of the via on surface 10a and/or surface 10b of substrate 10. Thus, a diameter at a top portion and a diameter at a bottom portion of through glass vias 40 are each greater than a diameter at a middle portion (waist) of the via. In some embodiments, the diameter at the top portion and the diameter at the bottom portion of through glass vias 40 are each in a range from about 10 microns to about 200 microns, or about 15 microns to about 150 microns, or about 20 microns to about 100 microns, or about 25 microns to about 75 microns, or about 50 microns to about 100 microns, or any range encompassing these endpoints.

Through glass vias 40 may have any suitable aspect ratio such as, for example, an aspect ratio of 1:1, 2:1, 3:1, 4:1, 5:1, 6:1, 7:1, 8:1, 9:1, 10:1, 15:1, 20:1, 30:1, 35:1 or any range having any two of these values as endpoints. It is also contemplated that other via geometries may be used in article 100.

Metal connectors 50 may comprise any electrically conductive metal material including the materials disclosed above with reference to metal coating 20. Although not shown in FIG. 2D, it is also contemplated that article 100 may comprise an adhesion layer 30 between surface modified region 14 and metal coating 20, between second surface modified region 14′ and second metal coating 20′, and/or between metal connectors 50 and substrate 10.

With reference again to FIG. 1, in the embodiments disclosed herein, bulk region 12 of substrate may have a thickness to from about 0.1 mm to about 3.0 mm, or about 0.4 mm to about 3.0 mm, from about 0.5 mm to about 3.0 mm, or about 0.55 mm to about 3.0 mm, or about 0.7 mm to about 3.0 mm, or about 1.0 mm to about 3.0 mm, or about 0.1 mm to about 2.0 mm, or about 0.1 mm to about 1.5 mm, or about 0.1 mm to about 1.0 mm, or about 0.1 mm to about 0.7 mm, or about 0.1 mm to about 0.55 mm, or about 0.1 mm to about 0.5 mm, or about 0.1 mm to about 0.4 mm, or about 0.3 mm to about 0.7 mm, or about 0.3 mm to about 0.55 mm, or any range encompassing these endpoints.

Surface modified region 14 and second surface modified region 14′ may each have a thickness tₛ of about 10 nm or greater, or about nm or greater, or about 20 nm or greater, or about 25 nm or greater, or about 30 nm or greater, or about 40 nm or greater, or about 50 nm or greater, or about 60 nm or greater, or about 70 nm or greater, or about 80 nm or greater, or about 90 nm or greater, or about 100 nm or greater, or about 200 nm or greater, or about 300 nm or greater, or about 400 nm or greater, or about 500 nm or greater, or about 750 nm or greater, or about 1,000 nm or greater, or about 1,500 nm or greater, or about 2,000 nm or greater. In embodiments, the thickness tₛ is from about 10 nm and about 10,000 nm, or about 15 nm to about 5,000 nm, or about 20 nm to about 2,000 nm, or about 25 nm to about 1,500 nm, or about 30 nm to about 1,000 nm, or about 40 nm to about 750 nm, or about 50 nm to about 500 nm, or about 60 nm to about 400 nm, or about 70 nm to about 300 nm, or about 80 nm to about 200 nm, or about 90 nm to about 100 nm, or any range encompassing these endpoints.

In some embodiments, the thickness tₛ of surface modified region 14 and of second surface modified region 14′ is less than the thickness tb of bulk region 12. Is it also contemplated, in embodiments, that the thickness of surface modified region 14 is different from the thickness of second surface modified region 14′.

As discussed further below, substrate 10 is exposed to a surface modification technique that causes at least one mobile modifier (e.g., a mobile alkali) to migrate away from the modified area within substrate 10. The modified area of substrate 10, with the reduced concentration of the mobile modifier, becomes surface modified region 14 and the remainder of substrate 10 becomes bulk region 12. Thus, bulk region 112 comprises one or more of alkali-metal oxides selected from Li₂O, Na₂O, K₂O, Rb₂O, and Cs₂O and/or alkaline-earth metal oxides selected from BeO, MgO, CaO, SrO, BaO, RaO, and Fr₂O while surface modified region 14 comprises a reduced concentration or is free of one or more of these oxides. Surface modified region 14 can be described as having a composition that differs from the alkali-containing bulk region 12 due to the concentration of one or more of the mobile modifiers (e.g., one or more of Li₂O, Na₂O, K₂O, Rb₂O, Cs₂O, BeO, MgO, CaO, SrO, BaO, RaO, and Fr₂O).

In embodiments, surface modified region 14 comprises a reduction of about 5 mol % or more of one or more alkali (e.g., one or more of Li₂O, Na₂O, K₂O, Rb₂O, Cs₂O, BeO, MgO, CaO, SrO, BaO, RaO, and Fr₂O) as compared with bulk region 12. For example, in one exemplary embodiment, surface modified region 14 comprises a reduction of about 5 mol % of one or more of Na₂O as compared with bulk region 12. In embodiments, surface modified region 12 comprises a reduction of 5 mol % or more, or about 10 mol % or more, or about 15 mol % or more, or about 20 mol % or more, or about 30 mol % or more, or about 40 mol % or more, or about 50 mol % or more, or about 60 mol % or more, or about 70 mol % or more, or about 80 mol % or more, or about 85 mol % or more, or about 90 mol % or more, or about 95 mol % or more, or about 99 mol % or more, or about 100 mol % of the one or more alkali, or any range encompassing these endpoints. In embodiments in which surface modified region 14 comprises a reduction of 100 mol % of the particular alkali as compared to bulk region 12, surface modified region 14 can be referred to as being “free” of the particular alkali.

In embodiments, surface modified region 14 comprises a reduction of about 5 mol % of one or more of a total concentration of alkali (e.g., a total concentration of Li₂O, Na₂O, K₂O, Rb₂O, Cs₂O, BeO, MgO, CaO, SrO, BaO, RaO, and Fr₂O) as compared with bulk region 12. In embodiments, surface modified region 12 comprises a reduction of 5 mol % or more, or about 10 mol % or more, or about 15 mol % or more, or about 20 mol % or more, or about 30 mol % or more, or about 40 mol % or more, or about 50 mol % or more, or about 60 mol % or more, or about 70 mol % or more, or about 80 mol % or more, or about 85 mol % or more, or about 90 mol % or more, or about 95 mol % or more, or about 99 mol % or more, or about 100 mol % of the total concentration of alkali, or any range encompassing these endpoints. In embodiments in which surface modified region 14 comprises a reduction of 100 mol % of the total concentration of alkali as compared to bulk region 12, surface modified region 14 can be referred to as being “free” of alkali.

In embodiments, surface modified region 14 comprises a total concentration of alkali (e.g., a total concentration of Li₂O, Na₂O, K₂O, Rb₂O, Cs₂O, BeO, MgO, CaO, SrO, BaO, RaO, and Fr₂O) of about 5.00 atomic % or less, or about 4.00 atomic % or less, or about 3.00 atomic % or less, or about 2.00 atomic % or less, or about 1.00 atomic % or less, or about 0.75 atomic % or less, or about 0.50 atomic % or less, or about 0.40 atomic % or less, or about 0.30 atomic % or less, or about 0.20 atomic % or less, or about 0.10 atomic % or less, or about 0.05 atomic % or less, or any range encompassing these endpoints such as, for example, in the range from about 5.0 atomic % to about 0.1 atomic %.

In embodiments, surface modified region 14 comprises a substantially homogenous composition. Thus, surface modified region 14 exhibits homogeneity in terms of composition and/or atomic structure within and throughout the region. Furthermore, surface modified region 14 is integral to substrate 10 and is not a coating or an additional material disposed on bulk region 12. In some embodiments, a sharp boundary may be defined within substrate 10 between bulk region 12 and surface modified region 14. In other embodiments, substrate 10 may transition between bulk region 12 and surface modified region 14 within a gradient of these two regions. The transition region between bulk region 12 and surface modified region 14 may have a length from about 1 nm to about 1,000 nm, or about 2 nm to about 7,500 nm, or about 5 nm to about 5,000 nm, or about 10 nm to about 2,500 nm, or about 25 nm to about 2,000 nm, or about 50 nm to about 1,000 nm, or about 100 nm to about 750 nm, or about 200 nm to about 500 nm, or about 1 nm to about 10 nm, or about 2 nm to about 8 nm, or about 4 nm to about 6 nm, or range encompassing these endpoints. In some embodiments, surface modified region 14 is substantially amorphous.

Surface modified region 14 may be substantially free of crystallites. For example, in embodiments, surface modified region 14 may comprise less than about 1 volume % crystallites.

In one or more embodiments, surface modified region 14 is substantially free of hydrogen (H⁺, H₃O⁺, H₂O or combinations therefrom). In embodiments, surface modified region 14 comprises about 0.1 atomic % hydrogen or less, or about 0.08 atomic % hydrogen or less, or about 0.06 atomic % hydrogen or less, or about 0.05 atomic % hydrogen or less, or about 0.04 atomic % hydrogen or less, or about 0.02 atomic % hydrogen or less, or about 0.01 atomic % hydrogen or less, or any range encompassing these endpoints. The low concentration of hydrogen of surface modified region 14 shows that surface modified region 14 was produced with the surface modification techniques disclosed herein rather than, for example, a chemical etching process.

In one or more embodiments, surface modified region 14 is substantially free of non-bridging oxygens. Furthermore, bulk region 12 may comprise such non-bridging oxygens or may also be substantially free of such non-bridging oxygens.

In embodiments, both bulk region 12 and surface modified region 14 comprise Al₂O₃ and SiO₂. In some embodiments, these regions of substrate 10 comprise Al₂O₃ in the range from about 1 mol % to about 50 mol %. In some embodiments, the amount of Al₂O₃ may be in the range from about 1 mol % to about 45 mol %, or about 1 mol % to about 40 mol %, or about 1 mol % to about 30 mol %, or about 1 mol % to about 25 mol %, or about 5 mol % to about 50 mol %, or about 10 mol % to about 50 mol %, or about 20 mol % to about 50 mol %, or about 30 mol % to about 50 mol %, or about 1 mol % to about 45 mol %, or about 5 mol % to about 35 mol %, or about 3 mol % to about 34 mol %, or any range encompassing these endpoints. Furthermore, these regions of substrate 10 comprise SiO₂ in a range from about 45 mol % to about 80 mol %, or about 50 mol % to about 75 mol %, or about 55 mol % to about 70 mol % or about 60 mol % to about 65 mol %, or any range encompassing these endpoints.

In one or more specific embodiments, surface modified region 14 comprises a binary Al₂O₃—SiO₂ composition, though other non-alkali components may be included.

As discussed above, substrate 10 is exposed to a surface modification technique in order to form surface modified region 14 (and second surface modified region 14′). Prior to such surface modification technique, the substrate may be referred to herein as a “precursor” glass or glass composition. The precursor glass composition comprises at least one mobile modifier, such as a mobile alkali. In embodiments, the precursor glass composition comprises alkali or alkaline-earth silicates, aluminosilicates, borosilicates, or boroaluminosilicates.

An exemplary precursor glass composition comprises SiO₂, B₂O₃ and Na₂O, where (SiO₂+B₂O₃)≥66 mol. %, and Na₂O≥9 mol. %. In an embodiment, the precursor glass composition includes at least 6 wt. % aluminum oxide. In a further embodiment, the precursor glass composition includes one or more alkaline earth oxides, such that a content of alkaline earth oxides is at least 5 wt. %. Suitable precursor glass compositions, in some embodiments, further comprise at least one of K₂O, MgO, and CaO. In a particular embodiment, the precursor glass compositions comprises: 61-75 mol. % SiO2; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example, the precursor glass composition comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. % (Li₂O+Na₂O+K₂O) 20 mol. % and 0 mol. % (MgO+CaO) 10 mol. %.

A still further example, the precursor glass composition comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. % (Li₂O+Na₂O+K₂O) 18 mol. % and 2 mol. % (MgO+CaO) 7 mol. %.

A still further example, the precursor glass composition comprises: 60.0-65.0 mol % SiO₂; 15.0-25.0 mol % Al₂O₃; 0-5.0 mol % B₂O₃; 5.0-20.0 mol % Na₂O; 0-10.0 mol % MgO; and 0-5.0 mol % SnO₂.

In some embodiments, the precursor glass composition comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σmodifiers (i.e., sum of modifiers) is greater than 1, where in the ratio the components are expressed in mol. % and the modifiers are alkali metal oxides. This precursor glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σmodifiers (i.e., sum of modifiers) is greater than 1.

In still another embodiment, the precursor glass composition comprises: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. % SiO₂+B₂O₃+CaO 69 mol. %; Na₂O+K₂O+B₂O₃+MgO+CaO+SrO≥10 mol. %; 5 mol. % MgO+CaO+SrO 8 mol. %; (Na₂O+B₂O₃)−Al₂O₃ 2 mol. %; 2 mol. % Na₂O−Al₂O₃ 6 mol. %; and 4 mol. % (Na₂O+K₂O)−Al₂O₃ 10 mol. %.

In yet some other embodiments, the precursor glass composition comprises: 2 mol % or more of Al₂O₃ and/or ZrO₂, or 4 mol % or more of Al₂O₃ and/or ZrO₂. Fining agents may be included in the precursor glass compositions described herein such as SnO2 and other known fining agents.

In one or more embodiments, the precursor glass composition may be substantially free of boron. For example, the precursor glass composition and/or the glass substrate after thermal poling treatment may include less than about 1 mol %, or less than about 0.1 mol % B₂O₃ or boron in any state.

Substrate 10 may be formed using various forming methods that include float glass processes and down-draw processes such as fusion draw and slot draw.

Surface modified region 14 (and second surface modified region 14′) may be formed on substrate 10 using a surface modification technique, which comprises depleting and/or removing the mobile modifier(s) (e.g., the mobile alkali) from this region of the substrate.

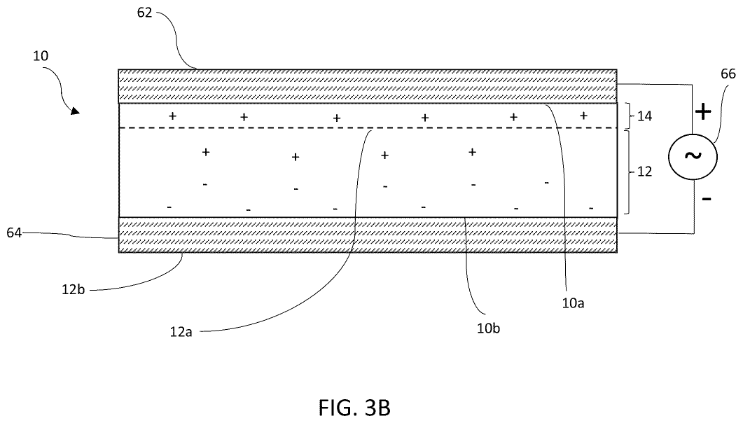

FIG. 3A shows an embodiment of an exemplary surface modification technique in which a thermal poling process is utilized. As discussed above, the composition of substrate 10 comprises a mobile modifier such as an alkali (one or more of Li₂O, Na₂O, K₂O, Rb₂O, Cs₂O, BeO, MgO, CaO, SrO, BaO, RaO, and Fr₂O). The thermal poling processes disclosed herein comprise reducing the concentration of the mobile modifier in surface modified region 14. Prior to such thermal poling treatment, substrate 10 may be cleaned or treated to remove typical contamination that can accumulate after forming, storage, and shipping.

The exemplary thermal poling processes disclosed herein comprise applying a first conductive member 62 to first surface 12a of substrate 10 and applying a second conductive member 64 to second surface 12b of substrate 10. As discussed further below, first conductive member 62 and second conductive member 64 may each comprise an electrode, metal coating 20, and/or adhesion layer 30. Once first conductive member 62 and second conductive member 64 are positioned on substrate 10, voltage source 66 generates an applied voltage to first and second conductive members 62, 64, which creates an electrical potential difference across substrate 10. Voltage source 66 powers first and second conductive members 62, 64 to create the electrical potential difference. The electrical potential difference across substrate 10 causes the mobile modifier to migrate from surface modified region 14 of substrate 10 and into bulk region 12 of substrate. Therefore, in embodiments, the electrical potential difference causes alkali to migrate from surface modified region 14 and into bulk region 12, thus causing the alkali depletion in surface modified region 14.

More specifically, as shown in the embodiment of FIG. 3B, the electrical potential difference caused by first and second conductive members 62, 64 and by voltage source 66 causes the portion of substrate 10 closer to first surface 10a to be positively charged and the portion of substrate 10 closer to second surface 10b to negatively charged. This potential difference across substrate 10 then causes the positively charged mobile modifiers, such as alkali modifiers, to migrate towards the negatively charged portion of substrate 10. Accordingly, the mobile modifiers migrate away from first surface 10a of substrate and towards second surface 10b of substrate, thus creating surface modified layer 14 at first surface 10a. Stated another way, the electrical potential difference across substrate 10 causes alkali depletion in the formed surface modified region 14.

In one exemplary embodiment, the potential difference across substrate 10, as shown in FIG. 3, for example, causes the positively charged Na₂O to migrate towards the negatively charged portion of substrate 10. Such causes a depletion of Na₂O in surface modified region 14. As is known in the art, the different alkali and alkaline earth metals may migrate at different rates within substrate 10 towards the negatively charged portion of the substrate. For example, it is known in the art that Na₂O is more mobile than MgO and will, therefore, migrate at a faster rate within substrate 10.

Formation of second surface modified layer 14′ may be formed using a similar process but in which the potential difference across substrate 10 is reversed so that the portion of substrate 10 closer to first surface 10a is negatively charged and the portion of substrate 10 closer to second surface 10b is positively charged. In embodiments, surface modified layer 14 and second surface modified layer 14′ may be formed simultaneously by alternating current between first and second conductive members 62, 64.

In some embodiments, first and second conductive members 62, 64 are each an electrode. In these embodiments, the material of first conductive member 62 may be the same or different form the material of second conductive member 64. Exemplary electrode materials include, for example, carbon, stainless steel, one or more noble metals (e.g., Au, Pt, Pd, etc.), one or more oxidation-resistant, conductive films (e.g., TiN, TiAlN, etc.), or combinations thereof.

In yet some embodiments, at least one of first conductive member 62 and second conductive member 64 is metal coating 20 (or a portion of metal coating 20). More specifically, the electrical potential across substrate 10 may be applied simultaneously while depositing metal coating 20 on substrate 10. Therefore, metal coating 20 may be deposited on substrate 10 simultaneously as the surface modification technique is conducted. Metal coating 20 is a conductive material that is configured to be charged by voltage source 66, as discussed above. In these embodiments, voltage source 66 generates the applied voltage to the metal coating of first conductive member 62 and/or second conductive member 64, which creates the electrical potential difference across substrate 10. The voltage applied to the metal coating may be applied simultaneously as the metal coating is being deposited on substrate 10, such as on first surface 10a and/or second surface 10b of substrate 10. In other embodiments, the voltage applied to the metal coating may be applied after the deposition of the metal coating on substrate 10.

In these embodiments in which metal coating 20 is deposited on substrate 10 simultaneously as the surface modification technique is being applied, the deposited metal coating may only comprise a thin, partial coating in order to provide the required conductivity. Therefore, first conductive member 62 and/or second conductive member 64 may only initially comprise a thin, partial coating. The thin, partial coating may have a thickness of about 1 nm or greater, or about 2 nm or greater, or about 3 nm or greater, or about 4 nm or greater, or about 5 nm or greater, or about 10 nm or greater, or about 15 nm or greater, or about 20 nm or greater, or about 50 nm or greater, or about 100 nm or greater, or any range encompassing these endpoints. As metal coating 20 continues to be deposited on substrate 10 during the deposition process, the thickness of this thin, partial coating will increase so that the thickness of first conductive member 62 and/or second conductive member 64 increases.

In some embodiments, first conductive member 62 comprises first metal coating 20 and second conductive member 64 comprises second metal coating 20′ so that the electrical potential difference across substrate 10 is created by the two metal coatings. In some particular embodiments, first conductive member 62 comprises first metal coating 20 and second conductive member 64 comprises second metal coating 20′ and the electrical potential difference across substrate 10 is created as these two metal coatings are being deposited on substrate 10. Thus, the metal coatings are deposited simultaneously as the thermal poling process.

In some embodiments, first conductive member 62 comprises first metal coating 20 and second conductive member 64 comprises an electrode. In some particular embodiments, the electrical potential difference across substrate 10 is created while first metal coating 20 is being deposited on substrate 10. Thus, first metal coating 20 is deposited simultaneously as the thermal poling process and wherein the thermal poling process utilizes an electrode as second conductive member 64.

In yet some embodiments, at least one of first conductive member 62 and second conductive member 64 is adhesion layer 30 (or a portion of adhesion layer 30). More specifically, the electrical potential across substrate 10 may be applied simultaneously while depositing adhesion layer 30 on substrate 10. Therefore, adhesion layer 30 may be deposited on substrate 10 simultaneously as the surface modification technique is conducted. Adhesion layer 30 is a conductive material that is configured to be charged by voltage source 66, as discussed above. In these embodiments, voltage source 66 generates the applied voltage to the adhesion layer of first conductive member 62 and/or second conductive member 64, which creates the electrical potential difference across substrate 10. The voltage applied to the adhesion layer may be applied simultaneously as the adhesion layer is being deposited on substrate 10, such as on first surface 10a and/or second surface 10b of substrate 10. In other embodiments, the voltage applied to the adhesion layer may be applied after the deposition of the adhesion layer on substrate 10.

In these embodiments in which adhesion layer 30 is deposited on substrate 10 simultaneously as the surface modification technique is being applied, the deposited adhesion layer may only comprise a thin, partial coating in order to provide the required conductivity. Therefore, first conductive member 62 and/or second conductive member 64 may only initially comprise a thin, partial coating. The thin, partial coating may have a thickness of about 1 nm or greater, or about 2 nm or greater, or about 3 nm or greater, or about 4 nm or greater, or about 5 nm or greater, or about 10 nm or greater, or about 15 nm or greater, or about 20 nm or greater, or about 50 nm or greater, or about 100 nm or greater, or any range encompassing these endpoints. As adhesion layer 30 continues to be deposited on substrate 10 during the deposition process, the thickness of this thin, partial coating will increase so that the thickness of first conductive member 62 and/or second conductive member 64 increases.

In some embodiments, first conductive member 62 comprises a first adhesion layer and second conductive member 64 comprises a second adhesion layer so that the electrical potential difference across substrate 10 is created by the two adhesion layers. In some particular embodiments, first conductive member 62 comprises a first adhesion layer and second conductive member 64 comprises a second adhesion layer and the electrical potential difference across substrate 10 is created as these two adhesion layers are being deposited on substrate 10. Thus, the adhesion layers are deposited simultaneously as the thermal poling process.

In some embodiments, first conductive member 62 comprises an adhesion layer and second conductive member 64 comprises an electrode. In some particular embodiments, the electrical potential difference across substrate 10 is created while the adhesion layer is being deposited on substrate 10. Thus, the adhesion layer is deposited simultaneously as the thermal poling process and wherein the thermal poling process utilizes an electrode as second conductive member 64.

In yet some embodiments, at least one of first conductive member 62 and second conductive member 64 is a combination of metal coating 20 and adhesion layer 30. More specifically, the electrical potential across substrate 10 may be applied simultaneously while depositing metal coating 20 and adhesion layer 30 on substrate 10. Therefore, metal coating 20 and adhesion layer 30 may be deposited on substrate 10 simultaneously as the surface modification technique is conducted.

When at least one of first conductive member 62 and second conductive members 64 comprises metal coating 20 and/or adhesion layer 30, metal coating 20 and/or adhesion layer 30 should preferably comprise a continuous coating on substrate 10 in order to provide the desired conductivity. However, it is also contemplated that metal coating 20 and/or adhesion layer 30 may comprise some discontinuity with, for example, some voids in the coating as long as metal coating 20 and/or adhesion layer 30 maintains the required level of conductivity.

In some embodiments, first surface 10a of substrate 10 is coated, either by metal coating 20 or adhesion layer 30 or a combination thereof, while second surface 10b of substrate 10 is coupled to an electrode. Thus, in these embodiments, first conductive member 62 is metal coating 20 and/or adhesion layer 30 and second conductive member 64 is an electrode. Furthermore, in these embodiments, first surface 10a is coated simultaneously as the thermal poling process is conducted. Once first surface 10a is sufficiently coated, second surface 10b of surface 10 may then be coated, either by metal coating 20 or adhesion layer 30 or a combination thereof. First conductive member 62 is now either the deposited coating on first surface 10a or an electrode coupled to first surface 10a and second conductive member 64 is metal coating 20 and/or adhesion layer 30 deposited on second surface 10b. Furthermore, second surface 10b is also coated simultaneously as the thermal poling process is conducted.

When at least one of first conductive member 62 and second conductive members 64 comprises metal coating 20 and/or adhesion layer 30 such that metal coating 20 and/or adhesion layer 30 is deposited on substrate 10 simultaneously as the surface modification technique is being applied, it has been shown by the inventors that components of metal coating 20 and/or adhesion layer 30 migrate into surface modified region 14. Therefore, surface modified region 14 comprises a higher concentration of one or more components of metal coating 20 and/or adhesion layer 30 than bulk region 12. In one exemplary embodiment, metal coating 20 comprises copper and is deposited on substrate 10 simultaneously as the surface modification technique is being applied, so that first conductive member 62 comprises the copper metal coating. In this exemplary embodiment, the formed surface modified region 14 comprises a higher concentration of copper than bulk region 12.

In embodiments, surface modified region 14 comprises a concentration of copper (Cu) from about 1 atomic wt. % to about 50 atomic wt. %, or about 2 atomic wt. % to about 45 atomic wt. %, or about 4 atomic wt. % to about 40 atomic wt. %, or about 5 atomic wt. % to about 35 atomic wt. %, or about 7 atomic wt. % to about 30 atomic wt. %, or about 10 atomic wt. % to about 25 atomic wt. %, or about 12 atomic wt. % to about 20 atomic wt. %, or about 14 atomic wt. % to about 18 atomic wt. %, or about 15 atomic wt. % to about 20 atomic wt. %, or about 16 atomic wt. % to about 20 atomic wt. %, or any range encompassing these endpoints.

The electrical potential difference applied to first and second conductive members 62, 64 may be applied using a time-varying or “pulsed” direct current (DC) waveform. In such embodiments, the duty cycle is configured to split the time between the DC voltage orientation across substrate 10. This repeating duty cycle alters the polarity of the first and second conductive members 62, 64 from anode to cathode in a repeating fashion, effectively generating a square alternating current (AC) waveform.

In some embodiments, the alternating electrical potential difference is applied to first and second conductive members 62, 64 using an AC waveform with a repeating duty cycle. One advantage of using an AC waveform is that the waveform can be customized based on the composition of substrate 10 and the desired thickness tₛ of surface modified region 14. Since the electrical properties of substrate 10 are frequency dependent, the AC waveform can be chosen in a manner that optimizes the dielectric response of the material of substrate 10. The working frequency range for thermal poling using an AC waveform exists below the frequency independent resistivity regime for DC conduction of glass. This lower frequency range is referred to as electrode polarization regime.

In one or more embodiments, the working frequency range is from about 0.001 Hz to about 500 Hz, or about 0.001 Hz to about 5 Hz, or about 0.001 Hz to about 2.5 Hz, or about 0.001 Hz to about 1 Hz, or about 0.001 Hz to about 0.9 Hz, or about 0.001 Hz to about 0.8 Hz, or about 0.001 Hz to about 0.7 Hz, or about 0.001 Hz to about 0.6 Hz, or about 0.001 Hz to about 0.5 Hz, or about 0.001 Hz to about 0.4 Hz, or about 0.001 Hz to about 0.3 Hz, or about 0.001 Hz to about 0.2 Hz, or about 0.001 Hz to about 0.1 Hz, or about 0.01 Hz to about 5 Hz, or about 0.01 Hz to about 2.5 Hz, or about 0.01 Hz to about 1 Hz, or about 0.02 Hz to about 1 Hz, or about 0.03 Hz to about 1 Hz, or about 0.04 Hz to about 1 Hz, or about 0.05 Hz to about 1 Hz, or about 0.06 Hz to about 1 Hz, or about 0.07 Hz to about 1 Hz, or about 0.08 Hz to about 1 Hz, or about 0.09 Hz to about 1 Hz, or about 0.1 Hz to about 1 Hz, or any range encompassing these endpoints.

Voltage source 66 may apply a voltage from about 50 volts to about 10,000 volts to create the electrical potential difference across substrate 10. In embodiments, the applied voltage is from about 75 volts to about 5,000 volts, or about 100 volts, to about 2,500 volts, or about 150 volts to about 2,000 volts, or about 200 volts to about 1,000 volts, or about 300 volts to about 900 volts, or about 400 volts to about 800 volts, or about 500 volts to about 700 volts, or any range encompassing these endpoints. The voltage may be applied for a duration of about 2 hours or less, or about 1.5 hours or less, or about 1 hours or less, or about 45 mins or less, or about 30 mins or less, or about 25 mins or less, or about 20 mins or less, or about 15 mins or less, or about 10 mins or less, or about 5 mins or less, or about 2 mins or less, or in a range from about 2 mins to about 2 hours, or about 5 mins to about 1.5 hours, or about 10 mins to about 1 hour, or about 15 mins to about 45 mins, or about 20 mins to about 30 mins, or about 20 mins to about 25 mins, or any range encompassing these endpoints. It should be noted that thermal poling treatment times and potentials can vary depending on the material of substrate 10.

In one or more embodiments, the electrical potential difference created within substrate 10 using pulsed DC waveforms or AC waveforms can include a DC offset towards one side of substrate 10 (towards either first side 10a or second side 10b of substrate 10). In these embodiments, both sides of substrate 10 are thermally poled to a certain extent, but one side of substrate 10 (i.e., the side on which the DC offset is directed) is subjected to preferential thermal poling. The preferential thermal poling can cause the thickness of the surface modified region (on the same side on which the DC offset is directed) to be greater than the thickness of the opposing surface modified region (on the opposite side on which the DC offset is directed). In some embodiments, the preferential thermal poling can also cause differences in the concentrations of mobile alkali within the opposing surface modified regions. For example, the preferential thermal poling can cause the mobile alkali concentration within one of the opposing surface modified regions (on the same side on which the DC offset is directed) to be less than the mobile alkali concentration within the other of the opposing surface modified region (on the opposite side on which the DC offset is directed).

In one or more embodiments, the electrical potential difference applied to first and second conductive members 62, 64 using pulsed DC waveforms or AC waveforms (with or without DC offset) has a voltage that can be increased as a function of time. In these embodiments, the thermal poling can cause the respective thicknesses of surface modified region 14 to be greater than the thicknesses that would otherwise be formed without such increase in total voltage as a function of time. In some embodiments, the increase in voltage over time can be applied in a manner that is stepped up in one or more discrete intervals over a time period. The time period can be a fixed time period. In other embodiments, the time period can vary such that the time period increases and/or decreases over the total thermal poling duration. In some embodiments, the increase in voltage over time can be applied in a manner that is ramped up linearly as a function of time. In some embodiments, the increase in voltage over time can be applied in a manner that is ramped up in a non-linear fashion as a function of time such that there is a greater increase in voltage at earlier times and a reduced increase in voltage at later times.

One advantage of applying the alternating electrical potential difference with an increase in voltage over time includes an ability to maximize the thickness of surface modified region 14 and second surface modified region 14′ while also reducing total process time. The various approaches also have an advantage in avoiding thermal dielectric breakdown with the passage of too much current through the glass substrate, especially with low-resistivity glasses, allowing for higher final poling voltages and thicker surface modified regions. Alternatively, as breakdown strength varies with glass composition, surface condition, and ambient temperature, an “instant-on” strategy for applying the alternating electrical potential difference can also be tolerated under some conditions for convenience.

Prior to or while creating the electrical potential difference, substrate 10 may be heated. In particular, substrate 10 may be heated to a temperature below the glass transition temperature (T_{g}) of substrate 10. In some embodiments, substrate 10 is heated to a temperature in a range from about 25° C. to about T_{g}, or from about 50° C. to about 350° C., or from about 100° C. to about 300° C., or from about 150° C. to about 250° C., or about 200° C. to about 300° C., or any range encompassing these endpoints. In some embodiments, equilibrium at the desired process temperature can be useful in thermal poling to ensure temperature uniformity. In some embodiments, substrate 10, first conductive member 62, and second conductive member 64 are heated concurrently together.

After the thermal poling treatment, substrate 10 can be cooled to a temperature in the range from about 25° C. to about 80° C. for subsequent handling. The alternating electrical potential difference can be removed prior to cooling or after cooling.

In yet some further embodiments, the electrical potential difference applied to first and second conductive members 62, 64 may not utilize voltage source 66. Instead, in some embodiments, first and second conductive members 62, 64 may be charged by other means such as, for example, by a charge on substrate 10 or by a plasma.

In embodiments, the material of first and second conductive members 62, 64 is substantially more conductive than the material of substrate 10 at the poling temperatures disclosed above to provide field uniformity over the first and second surfaces 10a, 10b of substrate 10. It is also desirable that the material of first and second conductive members 62, 64 is relatively oxidation resistant to minimize the formation of an interfacial oxide compound that could cause sticking of substrate 10 to the members.

In some embodiments, a surface modified region 14 is formed on a first substrate 10 using the above-disclosed surface modification techniques. Furthermore, a second surface modified region 14′ is formed on a second substrate 10 also using the above-disclosed surface modification techniques. In these embodiments, the first and second substrates are bonded, welded, or otherwise joined together (along their surfaces that were not modified with the surface modification techniques) in order to form article 100 with opposing surface modified regions.

In embodiments, substrate 10 after the surface modification technique (after the thermal poling treatment) comprises a refractive index in the range from about 1.45 to about 1.55 at a wavelength of 1550 nm, with surface modified region 14 exhibiting a lower refractive index than bulk region 12. In some embodiments, substrate 10 exhibits an average strain-to-failure at first surface 10a or second surface 10b that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In specific embodiments, substrate 10 exhibits an average strain-to-failure at first surface 10a or second surface 10b of about 1.2%, about 1.4%, about 1.6%, about 1.8%, about 2.2%, about 2.4%, about 2.6%, about 2.8%, or about 3% or greater.

In embodiments, substrate 10 after the surface modification technique (after the thermal poling treatment) exhibits increased elastic modulus as compared to substrate 10 before the surface modification technique. Therefore, the formation of surface modified region 14 may increase the elastic modulus of substrate 10. In embodiments, after the surface modification technique, substrate 10 exhibits an elastic modulus that is about 10% greater than the elastic modulus of substrate 10 before the surface modification technique. For example, after the surface modification technique (after the thermal poling treatment), substate 10 exhibits an elastic modulus of about 90 GPa.

In some embodiments, substrate 10 after the surface modification technique (after the thermal poling treatment) exhibits greater hardness as compared to substrate 10 before the surface modification technique. Therefore, the formation of surface modified region 14 may increase the hardness of substrate 10. In embodiments, after the surface modification technique, substrate 10 exhibits a hardness that is about 10% or about 20% greater than the hardness of substrate 10 before the surface modification technique. In one example, the hardness of substrate 10 before the surface modification technique is about 6 GPa, while the hardness of substrate 10 after the surface modification technique is about 7 GPa at indentation depths from about 0 nm to about 200 nm. Unless otherwise specified, the hardness values described herein refer to Vickers hardness.

After the surface modification technique (after the thermal poling process), the produced surface modified region 14 comprises a reduced conductivity as compared to bulk region 12 due to the depletion of alkali with surface modified region 14. In embodiments, surface modified region 14 comprises about a conductivity that is about 60% or less, or about 50% or less, or about 40% or less, or about 30% or less, or about 20% or less, or about 10% or less, or about 5% or less, or about 2% less as the conductivity of bulk region 12. The reduced conductivity of surface modified region 14 advantageously provides an electrical resistance between metal coating 20 and bulk region 12 of substrate 10, which creates insulation between metal coating 20 and bulk region 12. Such prevents/reduces electrical signals from leaking out of metal coating 20 and into bulk region 12, which helps to achieve low dielectric loss of substrate 10.

In embodiments disclosed herein, surface modified region 14 (and second surface modified region 14′) may block ion diffusion from metal coating 20 into bulk region 12 and may block ion diffusion from bulk region 12 into metal coating 20. Due to the formation of surface modified region 14 (and second surface modified region 14′), substrate 10 may exhibit an increased chemical durability in terms of resistance to dissolution in acid, water or base. In some examples, substrate 10 exhibits a decrease in dissolution rates in acid, water or base of about 1.5 times or more or even about 10 times or more.

### Example

A substrate comprising the composition listed in Table 1 was prepared and subjected to a thermal poling process. After the thermal poling process, a surface modified region was formed on a first side of the substrate and the remainder of the substrate formed a bulk region. The composition listed in Table 1 is provided in mol %, as measured by inductively coupled plasma optical emission spectrometry (ICP-OES).

TABLE 1

| | Mol % | | | | | |
|---|---|---|---|---|---|---|
| Example | SiO₂ | Al₂O₃ | B₂O₃ | Na₂O | MgO | SnO₂ |
| 1 | 67.6 | 12.7 | 3.7 | 13.7 | 2.3 | 0.1 |

The substrate of Example 1 was a rectangular panel with a length and width of 510 mm×515 mm. The substrate had a thickness of 0.4 mm.

For the thermal poling process, a copper (Cu) metal coating was deposited on a first surface of the substrate of Example 1, for use as the first conductive member, while the substrate was heated to a temperature between about 200° C. and 300° C. Furthermore, a bulk high-purity platinum (Pt) electrode was coupled to a second surface of the substrate, for use as the second conductive member. After equilibrating at a temperature in the range between 200° C. and 300° C. for about 15 minutes, a voltage of about +300V was applied to the metal coating on the first side of the substrate, with current limited to 1 mA maximum. An initial increase in current was observed, followed by a slow decay as the alkali-depleted surface region formed. The voltage was applied for a period of about 15 minutes, after which the heater was shut off and the stack of electrodes and the substrate was allowed to cool under voltage. When the temperature of the stack was less than about 100° C., the voltage was removed, the chamber was vented, and the stack was manually separated.

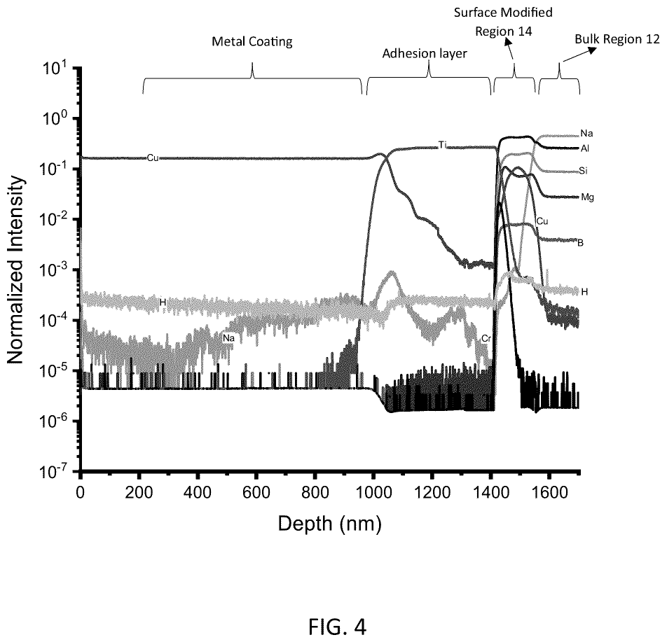

The presence, depth, and composition of the alkali-depleted surface region in the substrate was evaluated using secondary-ion-mass-spectrometry (SIMS). The result of this analysis is summarized in FIG. 4. In FIG. 4, the SIMS elemental depth profile is presented as concentrations of the relative components on the positively biased surface as a function of depth (nm).

FIG. 4 shows, in particular, the SIMS elemental depth profile for the substrate of Example 1 after the thermal poling process discussed above. As shown in FIG. 4, the produced surface modified region 14 comprises a relatively high concentration of Cu and a relatively low concentration of Na, as compared to bulk region 12. The relatively high concentration of Cu is due to the simultaneous deposition of the copper metal coating during the thermal poling process. Furthermore, FIG. 4 clearly shows the reduced concentration of Na in surface modified region 14 as compared to bulk region 12, highlighting the migration of Na from surface modified region 14 to bulk region 12.

The SIMS profile of FIG. 1 also shows a reduced H concentration in surface modified region 14, as compared to bulk region 12. As discussed above, the reduced H concentration in surface modified region 14 is an indicator of the structure of this glass region, showing that surface modified region 14 was created by thermal poling as opposed to, for example, a wet chemical etching process. Although not wishing to be bound by theory, it is thought that the Cu and Ti in the coating layers act as blocking agents for H, thus reducing the migration of H into surface modified region.

According to a first aspect, an article comprising a substrate with a first surface and a second surface and comprising a bulk region and a surface modified region, the bulk region being integral with the surface modified region, and the surface modified region being at the first surface of the substrate, the bulk region comprising a higher concentration of at least one alkali than the surface modified region, and a metal coating disposed on the first surface of the substrate.

According to a second aspect, the article of the first aspect, wherein the substrate comprises a glass or glass-ceramic substrate.

According to a third aspect, the article of the first or second aspects, wherein the at least one alkali comprises at least one of Li₂O, Na₂O, K₂O, Rb₂O, Cs₂O, BeO, MgO, CaO, SrO, BaO, RaO, Fr₂O.

According to a fourth aspect, the article of any one of the first through third aspects, wherein the metal coating comprises at least one of Cu, Mn, Ti, Sn, In, Cr, Mo, Al, Nb, Ta, Va, Zn, Ag, Ni, Au, Pt, and Pd.

According to a fifth aspect, the article of the fourth aspect, wherein the metal coating comprises Cu.

According to a sixth aspect, the article of any one of the first through fifth aspects, wherein the surface modified region comprises Cu.

According to a seventh aspect, the article of the sixth aspect, wherein the surface modified region comprises Cu in an amount from about 1 atomic wt. % to about 50 atomic wt. %.

According to an eighth aspect, the article of the seventh aspect, wherein the surface modified region comprises Cu in an amount from about 12 atomic wt. % to about 20 atomic wt. %.

According to a ninth aspect, the article of any one of the first through eighth aspects, wherein the surface modified region comprises a higher concentration of Cu than the bulk region.

According to a tenth aspect, the article of any one of the first through ninth aspects, wherein the surface modified region comprises a reduction of about 5 mol % of the at least one alkali as compared to the bulk region.

According to an eleventh aspect, the article of the tenth aspect, wherein the at least one alkali comprises Na.

According to a twelfth aspect, the article of any one of the first through eleventh aspects, wherein the surface modified region comprises a total concentration of alkali of about 5.00 atomic % or less.

According to a thirteenth aspect, the article of the twelfth aspect, wherein the surface modified region comprises a total concentration of alkali of about 1.00 atomic % or less.

According to a fourteenth aspect, the article of any one of the first through thirteenth aspects, further comprising a transition region between the surface modified region and the bulk region, the transition region having a length from about 1 nm to about 1,000 nm.

According to a fifteenth aspect, the article of any one of the first through fourteenth aspects, wherein the surface modified region has a thickness of about 10 nm or greater.

According to a sixteenth aspect, the article of the fifteenth aspect, wherein the thickness of the surface modified region is from about 10 nm to about 10,000 nm.

According to a seventeenth aspect, the article of the sixteenth aspect, wherein the bulk region has a thickness from about 0.1 mm to about 3.0 mm.

According to an eighteenth aspect, the article of any one of the first through seventeenth aspects, wherein the bulk region is thicker than the surface modified region.

According to a nineteenth aspect, the article of any one of the first through eighteenth aspects, wherein the surface modified region comprises a lower refractive index than the bulk region.

According to a twentieth aspect, the article of any one of the first through nineteenth aspects, wherein the surface modified region and the bulk region comprise SiO₂ and Al₂O₃.

According to a twenty-first aspect, a method of forming a modified surface region on a substrate, the method comprising depositing a metal coating on a first surface of the substrate, creating an electrical potential difference across the substrate while depositing the metal coating on the first surface of the substrate, and forming the modified surface region on the first surface of the substrate due to the electrical potential difference across the substrate, the modified surface region being integral with a bulk region of the substrate, and the modified surface region comprising a lower concentration of at least one alkali than the bulk region of the substrate.

According to a twenty-second aspect, the method of the twenty-first aspect, wherein the metal coating comprises at least one of Cu, Mn, Ti, Sn, In, Cr, Mo, Al, Nb, Ta, Va, Zn, Ag, Ni, Au, Pt, and Pd.

According to a twenty-third aspect, the method of the twenty-second aspect, wherein the metal coating comprises Cu.

According to a twenty-fourth aspect, the method of the twenty-third aspect, wherein the modified surface region comprises Cu.

According to a twenty-fifth aspect, the method of any one of the twenty-first through twenty-fourth aspects, wherein the at least one alkali comprises at least one of Li₂O, Na₂O, K₂O, Rb₂O, Cs₂O, BeO, MgO, CaO, SrO, BaO, RaO, Fr₂O.

According to a twenty-sixth aspect, the method of any one of the twenty-first through twenty-fifth aspects, wherein forming the modified surface region comprises creating the electrical potential difference across the substrate while the metal coating has an initial thickness of about 1 nm or greater and continuing to deposit the metal coating on the first surface of the substrate.

According to a twenty-seventh aspect, the method of any one of the twenty-first through twenty-sixth aspects, wherein creating the electrical potential across the substrate comprising applying an electrode to a second surface of the substrate.

According to a twenty-eighth aspect, the method of any one of the twenty-first through twenty-seventh aspects, further comprising depositing a second metal coating on a second surface of the substrate, creating an electrical potential across the substrate while depositing the second metal coating on the second surface of the substrate, and forming a second modified surface region on the second surface of the substrate due to the electrical potential difference across the substrate.

According to a twenty-ninth aspect, the method of the twenty-eighth aspect, further comprising depositing the metal coating on the first surface simultaneously as depositing the second metal coating on the second surface, and forming the modified surface region simultaneously as forming the second modified surface region.

According to a thirtieth aspect, the method of the twenty-eighth aspect, further comprising depositing the second metal coating on the second surface of the substrate after depositing the metal coating on the first surface of the substrate, and forming the second modified surface region after forming the modified surface region.

According to a thirty-first aspect, the method of any one of the twenty-first through thirtieth aspects, further comprising heating the substrate to a temperature from about 25° C. to a temperature below the glass transition temperature (T_{g}) of the substrate.

According to a thirty-second aspect, the method of the thirty-first article, wherein the glass is heated to a temperature from about 50° C. to about 350° C.

According to a thirty-third aspect, the method of any one of the twenty-first through thirty-second aspects, wherein the substrate comprises a glass or glass-ceramic substrate.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. An article comprising:
a substrate with a first surface and a second surface and comprising a bulk region and a surface modified region, the bulk region being integral with the surface modified region, and the surface modified region being at the first surface of the substrate,
the bulk region comprising a higher concentration of at least one alkali than the surface modified region; and
a metal coating disposed on the first surface of the substrate.

2. The article of claim 1, wherein the substrate comprises a glass or glass-ceramic substrate.

3. The article of claim 1, wherein the at least one alkali comprises at least one of Li₂O, Na₂O, K₂O, Rb₂O, Cs₂O, BeO, MgO, CaO, SrO, BaO, RaO, Fr₂O.

4. The article of claim 1, wherein the metal coating comprises at least one of Cu, Mn, Ti, Sn, In, Cr, Mo, Al, Nb, Ta, Va, Zn, Ag, Ni, Au, Pt, and Pd.

5. The article of claim 4, wherein the metal coating comprises Cu.

6. The article of claim 1, wherein the surface modified region comprises Cu.

7. The article of claim 6, wherein the surface modified region comprises Cu in an amount from about 1 atomic wt. % to about 50 atomic wt. %.

8. The article of claim 1, wherein the surface modified region comprises a reduction of about 5 mol % of the at least one alkali as compared to the bulk region.

9. The article of claim 1, wherein the at least one alkali comprises Na.

10. The article of claim 1, wherein the surface modified region comprises a total concentration of alkali of about 5.00 atomic % or less.

11. The article of claim 1, further comprising a transition region between the surface modified region and the bulk region, the transition region having a length from about 1 nm to about 1,000 nm.

12. The article of claim 1, wherein the surface modified region has a thickness of about 10 nm or greater.

13. The article of claim 1, wherein the bulk region has a thickness from about 0.1 mm to about 3.0 mm.

14. The article of claim 1, wherein the bulk region is thicker than the surface modified region.

15. The article of claim 1, wherein the surface modified region comprises a lower refractive index than the bulk region.

16. The article of claim 1, wherein the surface modified region and the bulk region comprise SiO₂ and Al₂O₃.

17. A method of forming a modified surface region on a substrate, the method comprising:
depositing a metal coating on a first surface of the substrate;
creating an electrical potential difference across the substrate while depositing the metal coating on the first surface of the substrate; and
forming the modified surface region on the first surface of the substrate due to the electrical potential difference across the substrate,
the modified surface region being integral with a bulk region of the substrate, and
the modified surface region comprising a lower concentration of at least one alkali than the bulk region of the substrate.

18. The method of claim 17, wherein the metal coating comprises at least one of Cu, Mn, Ti, Sn, In, Cr, Mo, Al, Nb, Ta, Va, Zn, Ag, Ni, Au, Pt, and Pd.

19. The method of claim 18, wherein the metal coating comprises Cu.

20. The method of claim 17, wherein the modified surface region comprises Cu.
